(19) United States
(12) Patent Application Publication
(10) Pub. No.: US 2008/0153952 A1
(43) Pub. Date: Jun. 26, 2008

(54) Closure liner for high-temperature applications

(75) Inventor: Terry D. Patcheak, Ypsilanti, MI (US)

Correspondence Address: OWENS-ILLINOIS, INC., ONE MICHAEL OWENS WAY, THREE O-I PLAZA, PERRYSBURG, OH, 43551-2999, US

(73) Assignee: Owens-Illinois Closure Inc.

(21) Appl. No.: 11/642,409

(22) Filed: Dec. 20, 2006

(51) Int. Cl. C08K 5/17; C08K 5/101; C08K 3/34

(52) U.S. Cl. 524/186; 525/240; 524/442; 524/284

(57) ABSTRACT

A liner for a plastic closure includes styrene-isobutylene-styrene (SIBS) blended with a resin polymer. This resin polymer preferably includes ethylene propylene diene monomer (EPDM rubber). The SIBS preferably is in an amount in the range of 10 to 90% by weight, more preferably 30 to 60% by weight, with an amount of about 46% by weight being particularly preferred. The resin polymer preferably is in an amount in the range of 10 to 90% by weight, more preferably 30 to 50% by weight, with an amount of about 41% by weight being particularly preferred. The EPDM rubber preferably is an elastomeric alloy of EPDM rubber and polypropylene. Mineral oil preferably is present, if at all, in an amount not more than 20% by weight. The liner may include up to 8% by weight process aids such as lubricant and up to 5% compatibilizer by weight.

The present disclosure relates to a liner for a plastic closure and particularly well suited for high-temperature applications such as hot-fill, aseptic fill, pasteurization and retort applications, and/or to a closure that includes such a liner.

### BACKGROUND AND SUMMARY OF THE DISCLOSURE

In high-temperature applications for a closure and container package, the package and the product within the package are subjected to elevated temperature during or after the filling process. For example, a package filled with a carbonated beverage can be subjected to storage under high-temperature conditions in which the temperature and internal pressure of the product within the package can increase dramatically. In other applications, the container can be filled with product while the product is hot, such as in so-called hot-fill and aseptic fill applications. In hot-fill applications for example, the product placed in the container can be at a temperature of 180 to 210° F. and remain at that temperature for several minutes after the container is capped. High-temperature applications also include applications in which the filled package is subjected to pasteurization or retort after filling and capping. During pasteurization for example, the temperature of the product within the package can be raised to 145 to 160° F. for 10 to 20 minutes. During retort, the temperature of the product within the package can be increased to 240 to 265° F. for 10 to 15 minutes and achieve an internal pressure of up to 50 psia. A general object of the present disclosure is to provide a liner for a plastic closure and/or a retort closure that includes such a liner, in which the liner is sufficiently robust to withstand high temperature and pressure conditions while maintaining seal integrity.

The present disclosure embodies a number of aspects that can be implemented separately from or in combination with each other.

A liner for a plastic closure, in accordance with one aspect of the present disclosure, includes styrene-isobutylene-styrene (SIBS) blended with a resin polymer. This resin polymer preferably includes ethylene propylene diene monomer (EPDM rubber). The SIBS preferably is in an amount in the range of 10 to 90% by weight, more preferably 30 to 60% by weight, with an amount of about 46% by weight being particularly preferred. The resin polymer preferably is in an amount in the range of 10 to 90% by weight, more preferably 30 to 50% by weight, with an amount of about 41% by weight being particularly preferred. The EPDM rubber preferably is an elastomeric alloy of EPDM rubber and polypropylene. Mineral oil is present, if at all, in an amount not more than 20% by weight. The liner may include up to 8% processing aids by weight, such as lubricant, and up to 5% compatibilizer by weight.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 a fragmentary partially sectioned elevational view of a package in accordance with a first exemplary implementation of the present disclosure; and

FIG. 2 is a fragmentary partially sectioned elevational view of a package in accordance with another exemplary implementation of the present disclosure.

### DETAILED DESCRIPTION OF PREFERRED EMBODIMENTS

A liner for a plastic closure, in accordance with exemplary embodiments of the present disclosure, includes styrene-isobutylene-styrene (SIBS) blended with a resin polymer. SIBS possesses oxygen barrier properties up to eight times better than styrene-butylene-styrene (SBS) and styrene-ethylene-butylene-styrene (SEBS) previously proposed for use in liners in plastic closures. Furthermore, the presence of isobutylene in SIBS greatly reduces the tendency of the liner to take a compression set. Moreover, SIBS is very soft, typically on the order of 40 shore A durometer, without the undesirable addition of mineral oil that typically is required when using SBS or SEBS to obtain the desired softness in the liner. In short, the use of SIBS results in a liner having robust sealing properties well suited for high-temperature applications.

In sealing liners in accordance with the present disclosure, the SIBS preferably is in an amount of 10 to 90% by weight, more preferably 30 to 60% by weight to achieve the desired softness and barrier properties, most preferably in the amount of about 46% by weight. (All percentages are by weight unless otherwise indicated.) The SIBS preferably is blended with a resin polymer that includes ethylene propylene diene monomer (EPDM) rubber. The EPDM/resin polymer preferably is in the amount of 10 to 90%, more preferably 30 to 50% to achieve the desired softness and barrier properties, with an amount of about 41% being particularly preferred. The EPDM rubber preferably is in the form of an elastomeric alloy of EPDM rubber and polypropylene, most preferably in a product marketed under the trade designation “Santoprene” or “Vyram.”

The liner of the present disclosure preferably does not include any mineral oil in addition to the extender included as a processing aid in the EPDM rubber/polymer. For example, the EPDM in rubber/polypropylene alloy marketed under the trade designation “Santoprene” includes mineral oil as a processing aid. When this resin polymer alloy is used in accordance with the present disclosure, mineral oil will be present in the liner composition in the amount of about 17 to 18%. Thus, the liner of the present disclosure preferably includes not more than 20% mineral oil (if it includes any mineral oil at all) and typically has a hardness of 57 Shore A. By way of comparison, in liners composed of SEBS, achievement of 65 Shore A hardness requires inclusion of more than 30% mineral oil. The liner of the present disclosure preferably includes a processing aid and a lubricant to reduce removal torque from the container neck finish. The lubricant preferably is selected from the group consisting of fatty acid amides, fatty acid esters, microcrystalline waxes, polyethylene glycols, primary amides, secondary amides, secondary bisamides, silicon, silicone oils and blends thereof. In a particularly preferred embodiment of the disclosure, the lubricant is in an amount of up to 8% by weight, and comprises a blend of 92% olefin polymer (linear low density polyethylene (LLDPE), high-density polyethylene (HDPE) or polypropylene(PP)), 5.7% erucamide and 2.3% ethylene-bis-oleamide. The liner preferably also includes a compatibilizer to promote adhesion between the liner and the plastic closure shell. The compatibilizer preferably is in an amount of up to 5%. The compatibilizer preferably is selected from the group consisting anhydride grafted polymers, ehylene vinyl acetate grafted polymers, ethylene methyl acrylates, ionomers and blends thereof. The compatibilizer most preferably is a maleic anhydride-grafted polypropylene marketed under the trade designation “Admer.”

A liner in accordance with the present disclosure preferably maintains sealing engagement with the container neck finish when applied with an application torque of at least 16 inch-pounds, the package is heated to a temperature of at least 250° F., holding that temperature for a time of at least one minute, and reducing the package to room temperature. An embodiment of the present disclosure including 46% SIBS, 41% EPDM rubber/polypropylene, 8% lubricant and 5% compatibilizer, and with no mineral oil in addition to that in the EPDM rubber/polypropylene, applied to a multilayer container having alternate layers of polypropylene (PP) and ethylene vinyl alcohol (EVOH), exhibited an oxygen permeation rate of less than 0.012 ccO₂/day. Inasmuch as SIBS typically has a hardness of 40 Shore A without mineral oil, the liner of the present disclosure preferably does not include mineral oil except when included as an extender oil in one of the other constituents. If a liner with a lower compression set is needed, a crosslinked version of SIBS can be used in place of the standard SIBS.

Tests were run to compare the seal survival characteristics of liners in accordance with the present disclosure compared with liners having SEBS instead of SIBS. Each set of closures had liners of 41% “Santoprene” (EPDM rubber/polypropylene), 5% compatibilizer marketed under the trade designation “Admer,” 8% lubricant (consisting of 0.46% erucamide, 0.18% ethylene-bis-oleamide and 7.36% olefin carrier), and 46% SIBS or SEBS. All closures were applied to PP/EVOH multilayer containers at a torque of 30 inch-pounds. All packages were retorted under identical conditions. All SIBS samples withstood an internal pressure of at least 82 psig without leaking. The SEBS samples leaked between 18 and 49 psig, with 22% leaking before reaching 36 psig.

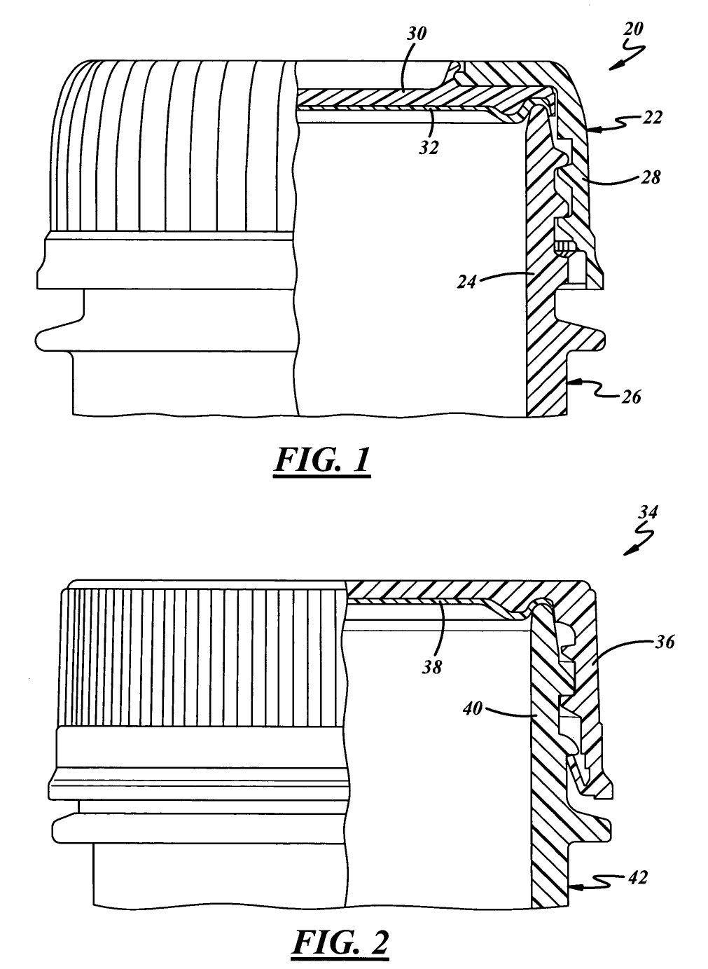

The drawings illustrate exemplary implementations of the present disclosure in retort packages. FIG. 1 illustrates a retort package 20 that includes a retort closure 22 applied to the neck finish 24 of a container 26. Closure 22 includes a molded plastic shell 28 having at least one internal thread segment engaged with external thread segments on neck finish 24. A plastic disk 30 is rotatably mounted within shell 28, and a sealing liner 32 is provided on disk 30, preferably by being compression molded in situ on the undersurface of disk 30. FIG. 2 illustrates a package 34 that includes a one-piece plastic closure shell 36 having a liner 38 applied to the undersurface of the closure base wall, preferably by being compression molded in situ on the undersurface of the base wall. Closure 36 is threaded onto the neck finish 40 of a container 42. Package 20 in FIG. 1 is similar to that disclosed in U.S. patent document 2005/0199574, and package 34 in FIG. 2 is similar to that disclosed in U.S. patent document 2003/0098286. The closures and packages illustrated in FIGS. 1 and 2 are by way of example only. Other retort and non-retort package configurations can be employed.

There thus have been disclosed a liner for a plastic closure, and a retort closure that includes such as liner, that fully achieve all of the objects and aims previously set forth. The disclosure has been presented in conjunction with exemplary embodiments, and additional modifications and variations have been described. Other modifications and variations readily will suggest themselves to persons of ordinary skill in the art in view of the foregoing discussion. The disclosure is intended to embrace all such modifications and variations as fall within the spirit and broad scope of the appended claims.

1. A liner for a plastic closure, which includes styrene-isobutylene-styrene (SIBS) blended with a resin polymer.

2. The liner set forth in claim 1 wherein said SIBS is in an amount in the range of 10 to 90% by weight.

3. The liner set forth in claim 2 wherein said SIBS is in the amount of 30 to 60% by weight.

4. The liner set forth in claim 2 wherein said SIBS is in the amount of about 46% by weight.

5. The liner set forth in claim 1 wherein said resin polymer includes ethylene propylene diene monomer (EPDM rubber).

6. The liner set forth in claim 5 wherein said resin polymer is in an amount in the range of 10 to 90 weight percent.

7. The liner set forth in claim 6 wherein said resin polymer is in the amount of 30 to 50% by weight.

8. The liner set forth in claim 7 wherein said resin polymer is in the amount of about 41% by weight.

9. The liner set forth in claim 8 wherein said resin polymer is an elastomeric alloy of EPDM rubber and polypropylene.

10. The liner set forth in claim 5 including mineral oil in an amount of not more than 20% by weight.

11. The liner set forth in claim 5 including up to 8% by weight processing aid, including lubricant.

12. The liner set forth in claim 11 wherein said lubricant is selected from the group consisting of fatty acid amides, fatty acid esters, microcrystalline waxes, polyethylene glycols, primary amides, secondary amides, secondary bisamides, silicone, silicone oils and blends thereof.

13. The liner set forth in claim 11 including up to 5% compatibilizer by weight.

14. The liner set forth in claim 13 wherein said compatibilizer is selected from the group consisting of anhydride grafted polymers, ethylene vinyl acetate grafted polymers, ethylene methyl acrylates, ionomers and blends thereof.

15. A retort closure that includes a plastic shell with at least one internal thread segment for receipt on an externally threaded container neck finish and a molded liner within said shell for sealing compression against the container neck finish,
said liner including styrene-isobutylene-styrene (SIBS) and ethylene propylene diene monomer (EPDM), not more than 20% by weight being mineral oil,
said closure liner maintaining sealing engagement with a container neck finish when applied with an application torque of at least 16 inch-pounds, heated to a temperature of at least 250° F., holding said temperature at least one minute, and then reducing the package to room temperature.

16. The closure set forth in claim 15 wherein said SIBS is in an amount in the range of 10 to 90% by weight.

17. The closure set forth in claim 16 wherein said SIBS is in the amount of 30 to 60% by weight.

18. The closure set forth in claim 16 wherein said SIBS is in the amount of about 46% by weight.

19. The closure set forth in claim 18 wherein said EPDM rubber is in an amount in the range of 10 to 90 weight percent.

20. The closure set forth in claim 19 wherein said EPDM rubber is in the amount of 30 to 50% by weight.

21. The closure set forth in claim 20 wherein said EPDM rubber is in the amount of about 41% by weight.

22. The closure set forth in claim 21 wherein said EPDM rubber is an elastomeric alloy of EPDM rubber and with polypropylene.

23. The closure set forth in claim 15 including up to 8% processing aid by weight, including lubricant.

24. The closure set forth in claim 23 wherein said lubricant is selected from the group consisting of fatty acid amides, fatty acid esters, microcrystalline waxes, polyethylene glycols, primary amides, secondary amides, secondary bisamides, silicone, silicone oils and blends thereof.

25. The closure set forth in claim 23 including up to 5% compatibilizer by weight.

26. The closure set forth in claim 25 wherein said compatibilizer is selected from the group consisting of anhydride grafted polymers, ethylene vinyl acetate grafted polymers, ethylene methyl acrylates, ionomers and blends thereof.

27. The closure set forth in claim 15 wherein said plastic shell is of one-piece integrally molded construction.

28. The closure set forth in claim 15 wherein said shell is of two-piece construction including a disk rotatably mounted within said shell and with said liner being molded to said disk.

29. The liner set forth in claim 1 wherein said SIBS is crosslinked.
